(19) United States
(12) Patent Application Publication
(10) Pub. No.: US 2004/0150215 A1
(43) Pub. Date: Aug. 5, 2004

(54) Personal goal tracking systems and methods

(76) Inventor: James D. King, Salt Lake City, UT (US)

Correspondence Address: GRAYBEAL, JACKSON, HALEY LLP, 155 - 108TH AVENUE NE, SUITE 350, BELLEVUE, WA, 98004-5901, US

(21) Appl. No.: 10/671,321

(22) Filed: Sep. 24, 2003

Related U.S. Application Data
(60) Provisional application No. 60/413,716, filed on Sep. 25, 2002.
(60) Provisional application No. 60/461,203, filed on Apr. 7, 2003.

(51) Int. Cl. B42D 15/00

(52) U.S. Cl. 283/62

(57) ABSTRACT

Goal tracking systems, apparatus, methods and the like comprising a board comprising a title area, a goal statement area and a sports activity field, at least the goal statement area and the sports activity field comprising an surface that is easily rewritable or suitable for easily moving symbols thereon. Also, a dry-erase stamp pad suitable for use with the systems or otherwise as desired.

### BACKGROUND

Setting personal goals is an important part of virtually everyone's life. Attaining such goals, however, is an even more important part. The difference between setting goals, or having dreams, and attaining those goals/achieving a desired reality, can be the difference between failure and success. Tools that assist a person to both set and attain goals are therefore useful for a variety of reasons. One manner in which such tools can assist is to solidify and track the goals.

Accordingly, there has gone unmet a need for tools that assist in the solidifying, tracking and/or attainment of goals. The present invention provides at least one of these or other, related advantages.

### SUMMARY

The present invention provides goal tracking systems, methods, etc., that help a person to write down their goals. The systems also help to track the goals, and to make the journey to attaining the goals fun and interesting. Thus, the systems also help a person to achieve his or her goals.

In some embodiments, the systems comprise a substrate having a surface that provides a plurality of useful areas for setting down, tracking and attaining goals. The systems can be implemented on a wood, metal, plastic, dry erase, magnetic, hook-and-loop fastening material or cloth board or on a computer screen or other device as desired. The tracking systems comprise, in certain embodiments, a title area that contains identification symbols for the goal tracking system, a goal statement area where the goal and certain steps to attain the goal can be written, and at least one activity area comprising a sports activity field such that tracking steps to achieve the goal can be combined with success on the athletic field. For example, if the athletic field is a football field, then achieving short term steps is rewarded by moving the football down the field. Similarly, failure to achieve certain short term steps can result in fewer yards gained or even lost yardage. The sports field can be any desired sport, for example, football, baseball, soccer, basketball, hockey, downhill skiing, racing with multiple simultaneous participants (such as a track meet, swim race, a car race, etc.) and the like.

Thus, in one aspect the present invention provides goal tracking systems comprising a substrate comprising a surface, the surface comprising a plurality of areas comprising a) at least one title area comprising first permanent markings that identify the systems as a goal tracking systems, b) at least one goal statement area comprising second permanent markings that identify the goal statement area, and at least one goal statement surface configured to removably retain easily removable goal statement symbols, and c) at least one activity area comprising third permanent markings defining at least one sports activity field comprising at least one sports activity surface configured to removably retain at least one easily movable activity symbol.

The goal statement surface can comprise an erasable substrate, the easily removable goal statement symbols comprise erasable writing, and the systems can further comprise the erasable writing on the erasable substrate of the goal statement surface. The erasable writing typically identifies at least one goal and at least one step for achieving the goal, and defines a correlation between the at least one step and movement of the movable activity symbol between a first, lower value location on the sports activity field and a second, higher value location on the sports activity field.

The second permanent markings of the goal statement area further comprise a “goal” word equivalent in conjunction with a goal writing area, and can further comprise a “short term,” or “short term” word equivalent. The goal writing area, the short term writing area, and the mid-level writing area can each further comprise erasable writing defining the goal and at least two steps. The systems can also comprise d) at least one positive slogan area comprising fourth permanent markings providing at least one positive slogan supporting the goal, or e) at least one scorekeeping area comprising fifth permanent markings that identify the scorekeeping area, and at least one scorekeeping surface configured to removably retain easily removable scorekeeping symbols.

The systems can further comprise at least one holder configured to hold at least one of a writing device and a moveable symbol. The holder can be a tray or hook or other desired element. The sports activity area can depict a football field or other desired sports arena, and can comprise an erasable substrate, at least one of a male side and a female side of a hook-and-loop type, or Velcro, fastening material hook-and-loop type fastening material, a computer screen, a magnetic board or a magnetic dry erase board. The first end zone of the football field can comprise permanent markings defining a “dream” word equivalent and a second end zone of the football field can comprise permanent markings defining a “reality” word equivalent.

In another aspect, the present invention provides goal tracking kits comprising, i) a goal tracking systems as discussed herein, and ii) the movable sports activity symbol configured to be moved about the sports activity surface. The kits can further comprise an erasable writing device.

In a further aspect, the present invention provides stamp pads sized and configured to provide ink to a rubber stamp, the stamp pads comprising a base and an ink-containing pad containing substantially only erasable ink. The ink-containing pad containing substantially only erasable ink can abuts a second ink-containing pad on the base. The erasable ink can be dry erase ink.

In still a further aspect, the present invention provides methods of goal tracking comprising: a) providing a goal statement on an identified goal statement area of a system or kit, etc., discussed herein, b) writing at least one step for achieving the goal in the goal statement area, the step defining a correlation between the step and moving the movable activity symbol between a first, lower value location on the sports activity field and a second, higher value location on the sports activity field, the movement indicating progress relative to the goal; and, c) moving the sports activity symbol about the sports activity field in accordance with the achievement of the steps. The methods can further comprise writing at least one “short term” word equivalent in a short term writing area and defining at least one short term step, and writing at least one “mid-level” word equivalent in a mid-level writing area and defining at least one mid-level step.

The writing can be erasable writing and the methods can further comprise keeping score of progress in at least one scorekeeping area of the surface comprising permanent markings that identify the scorekeeping area. The sports activity area can be a football field and the methods can further comprise moving a football symbol along the field, wherein attaining or losing yards can be correlated to successful completion of at least one of the steps. The football symbol can be initially placed at a first goal line associated with a “dream” word equivalent end zone, then the football symbol can be moved after a defined time period, wherein the amount and direction of movement of the football symbol can be determined according to the degree of completion of the steps during the defined time period. The time period can be one week.

The sports activity area can comprise an erasable substrate and moving the sports activity symbol can comprise applying dry erase ink from a rubber stamp to a first location of the sports activity area to provide a first applied symbol, erasing the applied symbol, and re-applying dry erase ink from the rubber stamp to a second location. The symbol can also be moved via a hook-and-loop type fastening material, a magnetic board or a computer screen.

In still another aspect, the present invention provides methods of goal tracking comprising: a) writing a goal on an erasable, identified goal statement area of a goal tracking system as discussed herein, b) writing at least one step for achieving the goal on the goal statement area, the writing defining a correlation between the step and moving the movable activity symbol between higher and lower value locations, and c) moving at least one movable sports activity symbol about the sports activity field in accordance with the achievement of the steps.

These and other aspects, features and embodiments are set forth within this application, including the following Detailed Description and attached drawings. Unless expressly stated otherwise or clear from the context, all embodiments, aspects, features, etc., can be mixed and matched, combined and permuted in any desired manner.

### BRIEF DESCRIPTION OF THE DRAWINGS

FIG. 1 depicts a schematic representation of a goal tracking system.

FIG. 2 depicts a chart of various exemplary goals and steps toward achieving the goals.

### DETAILED DESCRIPTION

The systems, etc., provide a substrate with a plurality of useful areas for setting down, tracking and attaining goals. The system can be a board or computer screen or other desired device and comprises, in certain embodiments, a title area, a goal statement area where the goal and steps to attain the goal can be written, and at least one activity area comprising a sports activity field such that tracking steps to achieve the goal can be combined with success on the field. If the athletic field is a football field, then achieving short term steps is rewarded by moving the football down the field. Similarly, failure to achieve certain short term steps can result in fewer yards gained or even lost yardage. If the field is a basketball court, then successful completion of intermediate steps can be rewarded with free throws, baskets, or even dunks or three pointers; failures can result in points for the “other team” or loss of points. The sports field can be any desired sport, for example, football, baseball, soccer, basketball, hockey, downhill skiing, racing with multiple simultaneous participants (such as a track meet, swim race, a car race, etc.) and the like.

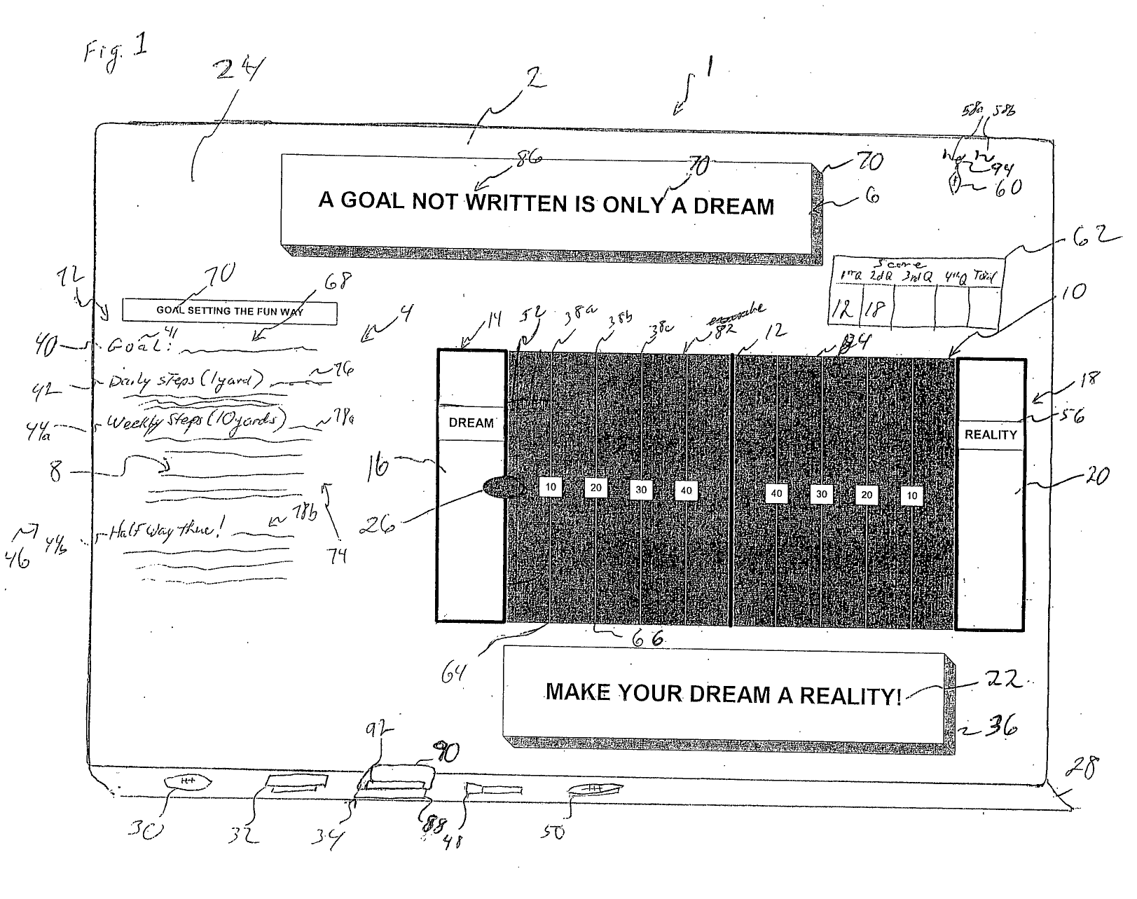

Turning to the Figures, FIG. 1 depicts one embodiment of a goal tracking system 1 comprising a substrate 2. The substrate 2 has a front 24 and a back, and comprises a plurality of defined areas. The substrate can be a board made of wood, metal, plastic, dry erase material, magnetic material, hook-and-loop fastening type material such as Velcro®, cloth, or even a computer screen if desired. The substrate is typically substantially planar, for example rectangular, but can also be cubical, triangular, pyramidal, spherical, or otherwise shaped as desired. The various areas on the substrate are typically separate, but can, if desired, overlap, abut, etc. In certain environments, for example on a computer screen, if desired the defined areas can be clicked and moved as a whole from one location on the substrate to another.

The goal tracking system 1 comprises a title area 6. As depicted, the title area 6 is centrally located toward the upper edge of substrate 2, but can be located in other positions if desired. The title area comprises permanent markings 70. Such markings can be provided via writing with a permanent marker, paint, decals, stitching, fabric, dye, or lines on a computer screen implemented by hardware or software prior to adjustment or writing by a user. As with other areas discussed herein, the specific configuration of the markings includes words identifying the area. Whether the markings include a box around the written statement as depicted in FIG. 1 or solely provide the written statement, or provide other features, can be modified as desired by a user. The title area 6 includes a title 86 that identifies the system as a goal tracking system. As depicted, the title is “A goal not written is only a dream.” Positive and instructional titles such as the title depicted can be preferred because they both suggest positive action to a user while also providing some guidance to the user (here, writing the goal in the goal tracking system).

The goal tracking system 1 further comprises both a goal statement area 4 and an activity area 10. The goal statement area 4 comprises permanent markings that identify the goal statement area. The goal statement area additionally comprises at least one goal statement surface 74 that is configured to removably retain easily removable goal statement symbols. Such configuration can be provided, for example, by a white board or dry erase board, a magnetic board, a magnetic dry erase board, a chalkboard, a user-variable section of a designated portion of a computer screen, etc. The goal statement symbols are typically provided by writing, for example, via a dry erase pen or by typing on a keyboard. The goal statement area 4 comprises a substantially modifiable, rewriteable surface 8 which can be blank, or have lines or a grid or other permanent markings indicating the location of the area and possibly guiding the writing of the goal.

The goal statement area typically comprises a goal statement 40 comprising a “goal” word equivalent (the word “goal” or any other word of equivalent meaning such as a synonym of goal, for example “result, objective, ambition, purpose, target, object, or aspiration). The goal statement area typically additionally comprises one or more short term steps 42 (or “short term” step word equivalent), which as depicted are identified as “daily steps” and are worth one yard on the football field depicted on athletic activity area 10. Goal statement area 4 typically also comprises one or more mid-level goals (or mid-level work equivalence), which as depicted are mid-level terms 44A, 44B “with weekly steps, which are worth ten yards, and half way there which indicates when the user is one half of the way to his or her goal.” Goal statement area 4 further comprises a goal statement area 72 comprising a goal statement surface 74 on which can be provided a goal discussion 46. As noted elsewhere, goal discussion 46 can be implemented via the use of an erasable marker 48 such as a dry erase marker. “Erasable marker” indicates a felt tip marking pen, a ballpoint-marking pen, pencil or any other suitable marking device or writing device, provided that it is has the indicated qualities. The goal word equivalent 41 is provided in conjunction with a goal writing area 68, the short term word equivalent 42 is provided in conjunction with a short term writing area 76, and the mid-level word equivalent is provided with at mid-level writing area 78A, 78B.

The writing, which is typically erasable writing, used to identify and discuss the goal in the goal statement area 4 typically defines a correlation between at least one of the steps recited to attain the goal and movement of the movable activity symbol 26. Accordingly, attaining the goal moves the activity symbol between a first, lower value location 64 on the sports activity field 12 and a second, higher value location 66 on the sports activity field 12. The movable activity symbol 26 can be moved from the lower to higher area or from the higher to lower area. In addition, since each area is typically relative, the higher area can become a lower area once the symbol is moved to that area. The movable activity symbol 26 can be applied to the sports activity field 12 via any desired approach including continuously movable devices such as magnets, Velcro-backed pieces, and zippers as well as discretely movable devices such as stampings, releasable adhesives, snaps, clips, and pins (some devices can be both or either discretely or continuously movable), or any other desired modality.

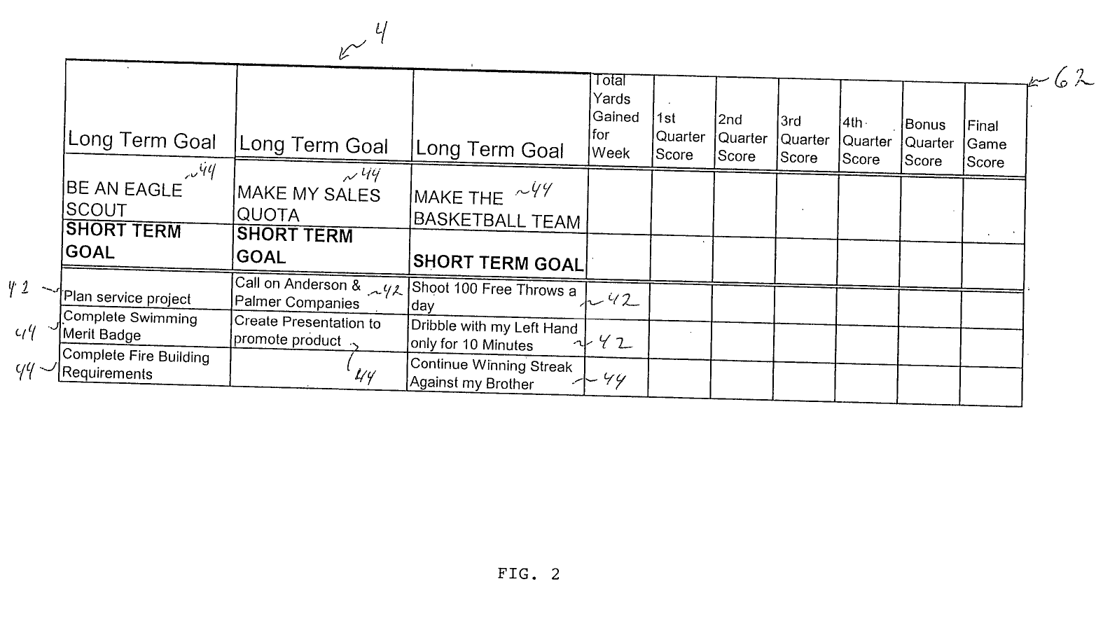

FIG. 2 depicts some exemplary goal statements 40 and some short term steps 42 and mid-level steps 44 toward achieving the goals. As depicted, the goal statements 40 include becoming an eagle scout, making a sales quota and making a basketball team. Short-term steps 42 and mid-level steps 44 include planning a service project, completing a swimming merit badge completing fire building requirements, calling on a customer, creating a sales presentation, shooting free throws, practicing dribbling with one's left hand, and playing and beating a particular opponent.

Returning to FIG. 1, activity area 10 comprises at least one sports activity field 12. In turn, sports activity field 12 comprises at least one sports activity surface configured to removably retain at least one easily movable activity symbol 26, which as depicted is a football. As depicted, sports activity field 12 is a football field and progresses from left to right, from a dream area 14 (or word equivalent) to a reality area 18 (or word equivalent). “Sports activity field” indicates any sports activity location, for example a tennis court, swimming pool, racetrack, hockey rink, etc. The dream area 14 is located in the first end zone 16 and reality area 18 is located in a second end zone 20. The sports activity field 12 further comprises a plurality of yard lines 38a, 38b, 38c, including, if desired, single yard markers 52. 5-yard and 10-yard markers, or other desired distances, can also be used. The sports activity field 12 can comprise an erasable substrate which provides for erasable writing thereon, or other suitable substrates as desired. In FIG. 1, sports activity field 12 comprises an erasable surface 82 for one half of the field and a felt surface 84 suitable for use with a Velcro-containing movable symbol for the other half. Accordingly, the sports activity field 12 provides for lower value and higher value locations. In the embodiment depicted the lower value location 64 is closer to the dream are 14, while the higher value location 66 is closer to the reality value location 18.

The substrate 2 can also contain a positive slogan 22 disposed in a positive slogan area 36. As depicted, the positive slogan states “Make Your Dream a Reality!” The positive slogan area 36 can, similar to other areas discussed herein such as title area 6, be provided with a variety of markings, including positive slogan 22, lines or other markings as desired. Scorekeeping area 62 comprises at least one score keeping surface configured to removably retain score keeping symbols. As depicted, the scorekeeping area 62 is divided into four quarters and a total to provide five spaces for keeping a running tally of the score. The scorekeeping area 62 can be configured as desired for a given goal or for a given sport. Typically, scorekeeping area 62 is enclosed by permanent markings, as with certain other areas discussed herein.

The goal tracking system 1 can, if desired, additionally comprise a tray 28 or hooks 58a, 58b configured to retain one or more writing implements, movable symbols and the like. Such tray 28 and hooks 58a, 58b are exemplary of a holder configured to hold at least one of a movable device and a movable symbol or other items as desired. For example, suitable symbols include a supplemental movable symbol such as second football 30, which football on one side comprises either a male side or a female side of a hook-and-loop fastening type material such as Velcro (in which case the sports activity field would typically comprise the corresponding side of the hook-and-loop type fastening material.) Tray 28 additionally holds rubber stamp 32 and rubber stamp pad 34. Rubber stamp 34 can be made of any desired material, such as rubber, wood cut, plastic, etc. Tray 28 additionally holds an erasable marker 48 and a magnetic football 50, while hook 58a holds a movable symbol 60 dangling from a toroidal snap 94. An easily movable activity symbol is a symbol that can be moved without significant effort, for example, via sliding as with a magnet, or by removing and replacing as with a stamped figure, Velcro piece or magnet, or by clicking and dragging as with a computer icon.

The rubber stamp pad 34 comprises a base 88, a top 90 (shown in open position), and an ink-containing pad 92. In certain embodiments, the rubber stamp pad 34, including the ink-containing pad 92 therein, are filled with an erasable ink, such as a dry-erase ink. Such a stamp pad can be used for any desired purpose relating to the application of erasable ink, such as the application of such ink to a dry erase board or other erasable surface, etc. Accordingly, the apparatus and methods, etc., discussed herein include the erasable stamp pad discussed herein including for purposes other than the goal tracking systems, etc., herein.

If desired, the goal tracking system 1 can be combined with one or more of the movable symbols 26 in a kit. Such a kit may or may not be provided in a single container as desired. If desired, the goal tracking system 1, with or without the movable symbol, can additionally comprise a kit comprising the goal tracking system 1 and at least one erasable marker 48.

Turning to some methods, the methods include manufacturing the goal tracking system 1 by applying appropriate markings to a suitable substrate in such relation to each other to provide the devices and systems discussed herein. In addition, methods of manufacturing can comprise combining such systems with one or more suitable movable symbols, or an erasable marker 48 or other desired writing device. Such movable symbols typically depict players, playing equipment (such as balls, bats, sticks, etc.) and the like that are specifically correlated to the sport depicted in the sports activity field.

Other methods include methods of playing, implementing or otherwise using the systems and kits, etc., discussed herein. For example, a method of goal tracking can comprise providing a goal statement on an identified goal statement area comprising at least one goal statement surface that is configured to removably retain an easily removable goal statement symbol. The goal statement area can comprise a part of a goal tracking system as discussed herein comprising at least one title area, the goal statement area and at least one identified sports activity field comprising at least one sports activity surface that is also configured to removable retain at least one easily movable activity symbol. Next, the methods can comprise writing at least one step for achieving the goal in the goal statement area. The writing defines a correlation between the step and moving the movable activity symbol between a first, lower value location on the sports activity field and a second, higher value location on a sports activity field, the movement thereby indicating progress (including negative progress) relative to the ultimate goal. The method typically further comprises moving the sports activity symbol about the sports activity field in accordance with the achievement (including the lack thereof) of the steps.

Typically, the methods further comprise writing at least on “short term” word equivalent in a short term writing area, defining at least one short-term step thereby. Further, the method typically comprises writing at least one “mid-level” word equivalent in the mid-level area and defining at least one mid-level step thereby. Typically the writing is erasable writing, for example via an erasable marker or keyboarding.

The method can further comprise keeping score of the progress in at least one scorekeeping area on the surface of the system, the scorekeeping area comprising substantially permanent markings that identify the scorekeeping area. In certain embodiments, the sports activity area can be a football field and the method can further comprise moving a football symbol along the field. The yards can be attained or lost in correlation to successful, or unsuccessful completion of at least one of the steps.

For example, the football symbol can initially be placed at a first goal line associated with a “dream” word equivalent end zone. The football can then be moved after a defined time period wherein the amount and direction of movement of the football symbol is determined according to the degree of completion of the step(s) during the defined time period. The time period can be any desired time, for example a day, a week, a month, or even an hour or a year. As discussed elsewhere herein, the sports activity area can comprise any of a variety of desired substrates, and the sports activity symbol can comprise any of a variety of corresponding devices. For example, the sports activity area can comprise an erasable substrate while the sports activity symbol comprises dry erase ink applied via a rubber stamp or other desired device. Moving the sports activity symbol can then comprise erasing the first applied symbol and then reapplying the dry erase ink to a second location to provide a second applied symbol (if desired, the applied symbols can be applied intact). Similarly, the sports activity area can comprise at least one of the male or female sides of a Velcro-type fastening system, with the sports activity symbol comprising the corresponding side. Moving the sports activity symbol can then comprise attaching the sports activity symbol to a first location and then removing the symbol and then reapplying it to a second location. Moving be also implemented with magnetic boards-magnetic sports activity symbols, and with computer screens-drag and clicking computer generated icons or otherwise as desired.

In another approach, the methods can comprise writing the goal on an erasable goal identified goal statement area of a goal tracking system, which goal tracking system may not comprise a title area, the surface of the goal tracking system comprising a sports activity area as discussed herein. In such a situation, the goal should comprise an end result other than merely playing the game depicted in the given field for the sporting event. For example, using a football field-based system, the goal, as depicted in FIG. 2, could be becoming an eagle scout, making a sales quota or making a basketball team. If the long-term goal is to be an eagle scout then short-term and mid-level steps can include planning a service project, completing a swimming merit badge and completing fire building requirements. If the long-term goal is to make a sales quota, then the short-term goal can be calling on a given company and a mid-level goal can be creating a presentation to promote the product to be sold. Similarly, if the ultimate goal is to make the basketball team, then the short-term goals can be to shoot 100 free throws a day and to practice dribbling with one's left hand for 10 minutes a day, and a mid-level or intermediate goal can be to continue a playing and beating particular opponent.

The progress of the goals can be kept on the scorekeeping area. Briefly, scorekeeping area includes columns for total yards gained for a given week, quarterly scores for the 4 given quarters, a bonus quarter score if desired (for example, for unusually good performance within one of the quarters or to provide a fifth recording period where desired), and a final game score which, hopefully, will be attaining all 100 yards and a touchdown in the “reality” end zone.

For computer-based implementations of the systems and methods, etc., herein, such can be implemented on a single computer such as a personal computer or a laptop computer, over an intranet or internet, in groups or individually or otherwise as desired. Further, there can be a host or manager that can access each participant's progress for tracking, monitoring, or other passive or interactive purpose (participants can likewise be selectively permitted to view each other's progress or be blocked from seeing each other's progress, or intermediate variations thereof where some persons can view some others' progress, but not all, etc.). Further, there can be at least one functionality button associated with a given screen, which can permit multiple viewings, manipulation of data, goals, etc., by the manager or host or other person as desired, the ability to modify specific themes (such as whether the goal-oriented activity is a football game, a track meet, climbing a mountain, or changing the value of given goal, for example increasing mountain height from 2,000 feet elevation to 3,000 feet elevation, or adding or deleting mileposts along the way), and the like. Thus, the systems can be interactively updated, modified, amended, etc., to provide positive reinforcement or other purposes.

If desired, the systems can further comprise using a photograph or other specific representation of a participant or user. This can be, for example, an actual paper photograph with hard-version game boards such as dry erase boards, or digital photos for use with computer-implemented systems.

The preceding paragraphs provide definitions of some of the terms used herein. All terms used herein are used in accordance with their ordinary meanings unless the context or definition clearly indicates otherwise. Also unless indicated otherwise, except within the claims, the use of “or” includes “and” and vice-versa. Non-limiting terms are not to be construed as limiting unless expressly stated, or the context clearly indicates, otherwise (for example, “including,” “having,” and “comprising” typically indicate “including without limitation”). Singular forms, including in the claims, such as “a,” “an,” and “the” include the plural reference unless expressly stated, or the context clearly indicates, otherwise.

The scope of the present systems and methods, etc., includes both means plus function and step plus function concepts. However, the terms set forth in this application are not to be interpreted in the claims as indicating a “means plus function” relationship unless the word “means” is specifically recited in a claim, and are to be interpreted in the claims as indicating a “means plus function” relationship where the word “means” is specifically recited in a claim. Similarly, the terms set forth in this application are not to be interpreted in method or process claims as indicating a “step plus function” relationship unless the word “step” is specifically recited in the claims, and are to be interpreted in the claims as indicating a “step plus function” relationship where the word “step” is specifically recited in a claim. “Step” as discussed in this paragraph regarding “step plus function” is to be distinguished from the usage of “step” herein when discussing the steps to be taken to attain a goal.

From the foregoing, it will be appreciated that, although specific embodiments have been discussed herein for purposes of illustration, various modifications may be made without deviating from the spirit and scope of the disclosure. Accordingly, the systems and methods, etc., include such modifications as well as all permutations and combinations of the subject matter set forth herein and is not limited except as by the appended claims.

What is claimed is:

1. A goal tracking system comprising a substrate comprising a surface, the surface comprising a plurality of areas comprising a) at least one title area comprising first permanent markings that identify the system as a goal tracking system, b) at least one goal statement area comprising second permanent markings that identify the goal statement area, and at least one goal statement surface configured to removably retain easily removable goal statement symbols, and c) at least one activity area comprising third permanent markings defining at least one sports activity field comprising at least one sports activity surface configured to removably retain at least one easily movable activity symbol.

2. The system of claim 1 wherein the goal statement surface comprises an erasable substrate, the easily removable goal statement symbols comprise erasable writing, and the system further comprises the erasable writing on the erasable substrate of the goal statement surface, the erasable writing identifying at least one goal and at least one step for achieving the goal.

3. The system of claim 1 or 2 wherein the erasable writing further defines a correlation between the at least one step and movement of the movable activity symbol between a first, lower value location on the sports activity field and a second, higher value location on the sports activity field.

4. The system of any one of claims 1 to 3 wherein the second permanent markings of the goal statement area further comprise at least one “goal” word equivalent in conjunction with a goal writing area.

5. The system of any one of claims 1 to 4 wherein the second permanent markings of the goal statement area further comprise at least one “short term” word equivalent in conjunction with a short term writing area.

6. The system of any one of claims 1 to 5 wherein the second permanent markings of the goal statement area further comprise at least one “mid-level” word equivalent in conjunction with a mid-level writing area.

7. The system of claim 6 wherein the goal writing area, the short term writing area, and the mid-level writing area each further comprise erasable writing defining the goal and at least two steps.

8. The system of any one of claims 1 to 7 wherein the system further comprises d) at least one positive slogan area comprising fourth permanent markings providing at least one positive slogan supporting the goal.

9. The system of any one of claims 1 to 8 wherein the system further comprises e) at least one scorekeeping area comprising fifth permanent markings that identify the scorekeeping area, and at least one scorekeeping surface configured to removably retain easily removable scorekeeping symbols.

10. The system of any one of claims 1 to 9 wherein the system further comprises at least one holder configured to hold at least one of a writing device and a moveable symbol.

11. The system of claim 10 wherein the holder is a tray.

12. The system of claim 10 wherein the holder is a hook.

13. The system of any one of claims 1 to 12 wherein the sports activity area is a football field.

14. The system of any one of claims 1 to 13 wherein the sports activity area comprises an erasable substrate.

15. The system of any one of claims 1 to 13 wherein the sports activity area comprises at least one of a male side and a female side of a hook-and-loop type fastening material hook-and-loop type fastening material.

16. The system of any one of claims 1 to 13 wherein the sports activity area comprises a defined section of a computer screen.

17. The system of any one of claims 1 to 13 wherein the sports activity area comprises a magnetic board.

18. The system of any one of claims 1 to 13 wherein the sports activity area comprises a magnetic dry erase board.

19. The system of any one of claims 13 to 18 wherein a first end zone of the football field comprises permanent markings defining a “dream” word equivalent and a second end zone of the football field comprises permanent markings defining a “reality” word equivalent.

20. A goal tracking kit comprising
i) a goal tracking system comprising a substrate comprising a surface, the surface comprising a plurality of areas comprising a) at least one title area comprising first permanent markings that identify the system as a goal tracking system, b) at least one goal statement area comprising an erasable surface and second permanent markings that identify the goal statement area, and c) at least one activity area comprising third permanent markings defining at least one sports activity field comprising at least one sports activity surface configured to removably retain at least one easily movable activity symbol; and
ii) the movable sports activity symbol configured to be moved about the sports activity surface.

21. The kit of claim 20 wherein the kit further comprises an erasable writing device.

22. The kit of claim 20 or 21 wherein the system further comprises the erasable writing on the goal statement surface, the erasable writing identifying at least one goal and at least one step for achieving the goal, the erasable writing further defining a correlation between the at least one step and moving the movable activity symbol between a first, lower value location on the sports activity field and a second, higher value location on the sports activity field.

23. The kit of any one of claims 20 to 22 wherein the second permanent markings of the goal statement area further comprise at least one “goal” word equivalent in conjunction with a goal writing area.

24. The kit of any one of claims 20 to 23 wherein the second permanent markings of the goal statement area further comprise at least one “short term” word equivalent in conjunction with a short term writing area.

25. The kit of any one of claims 20 to 24 wherein the second permanent markings of the goal statement area further comprise at least one “mid-level” word equivalent in conjunction with a mid-level writing area.

26. The kit of claim 25 wherein the goal writing area, the short term writing area, and the mid-level writing area each further comprise erasable writing defining the goal and at least two steps.

27. The kit of any one of claims 20 to 26 wherein the system further comprises d) at least one positive slogan area comprising fourth permanent markings providing at least one positive slogan supporting the goal.

28. The kit of any one of claims 20 to 27 wherein the system further comprises e) at least one scorekeeping area comprising fifth permanent markings that identify the scorekeeping area, and at least one erasable scorekeeping surface.

29. The kit of any one of claims 20 to 28 wherein the system further comprises at least one holder configured to hold at least one of a writing device and a moveable symbol.

30. The kit of claim 29 wherein the holder is a tray.

31. The kit of claim 29 wherein the holder is a hook.

32. The kit of any one of claims 20 to 22 wherein the sports activity area is a football field.

33. The kit of claim 29 wherein the movable sports activity symbol is a football.

34. The system of any one of claims 20 to 33 wherein the sports activity area comprises an erasable substrate and the movable sports activity symbol is a rubber stamp.

35. The kit of claim 34 wherein the kit further comprises a stamp pad sized and configured to provide ink to the rubber stamp, the stamp pad comprising a base and an ink-containing pad containing substantially only dry erase ink.

36. The system of any one of claims 20 to 33 wherein the sports activity area comprises at least one of a male side and a female side of a hook-and-loop type fastening material and the movable sports activity symbol comprises the corresponding side of the hook-and-loop type fastening material.

37. The system of any one of claims 20 to 33 wherein the sports activity area comprises a magnetic board.

38. The system of any one of claims 32 to 36 wherein a first end zone of the football field comprises permanent markings defining a “dream” word equivalent and a second end zone of the football field comprises permanent markings defining a “reality” word equivalent.

39. A stamp pad sized and configured to provide ink to a rubber stamp, the stamp pad comprising a base and an ink-containing pad containing substantially only erasable ink.

40. The stamp pad of claim 39 wherein the ink-containing pad containing substantially only erasable ink abuts a second ink-containing pad on the base.

41. The stamp pad of claim 39 wherein the erasable ink is dry erase ink.

42. A method of goal tracking comprising:
a) providing a goal statement on an identified goal statement area comprising at least one goal statement surface configured to removably retain at least one easily removable goal statement symbol, wherein the goal statement area comprises a part of a goal tracking system, the goal tracking system comprising a substrate comprising a surface, the surface comprising a plurality of areas comprising a) at least one title area comprising first permanent markings that identify the system as a goal tracking system, b) the identified goal statement area, and c) at least one identified sports activity field comprising at least one sports activity surface configured to removably retain at least one easily movable activity symbol;
b) writing at least one step for achieving the goal in the goal statement area, the step defining a correlation between the step and moving the movable activity symbol between a first, lower value location on the sports activity field and a second, higher value location on the sports activity field, the movement indicating progress relative to the goal; and,
c) moving the sports activity symbol about the sports activity field in accordance with the achievement of the steps.

43. The method of claim 42 wherein the method further comprises writing at least one “short term” word equivalent in a short term writing area and defining at least one short term step, and writing at least one “mid-level” word equivalent in a mid-level writing area and defining at least one mid-level step.

44. The method of claim 42 or 43 wherein the writing is erasable writing.

45. The method of any one of claims 42 to 43 wherein the method further comprises keeping score of progress in at least one scorekeeping area of the surface comprising permanent markings that identify the scorekeeping area.

46. The method of any one of claims 42 to 45 wherein the sports activity area is a football field and the method further comprises moving a football symbol along the field, wherein attaining or losing yards is correlated to successful completion of at least one of the steps.

47. The method of claim 46 wherein the football symbol is initially placed at a first goal line associated with a “dream” word equivalent end zone, then the football symbol is moved after a defined time period, wherein the amount and direction of movement of the football symbol is determined according to the degree of completion of the steps during the defined time period.

48. The method of claim 47 wherein the time period is one week.

49. The method of any one of claims 42 to 48 wherein the sports activity area comprises an erasable substrate and moving the sports activity symbol comprises applying dry erase ink from a rubber stamp to a first location of the sports activity area to provide a first applied symbol, erasing the applied symbol, and re-applying dry erase ink from the rubber stamp to a second location of the sports activity area to provide a second applied symbol.

50. The method of any one of claims 42 to 48 wherein the sports activity area comprises at least one of a male side and a female side of a hook-and-loop type fastening material and the sports activity symbol comprises the corresponding side of the hook-and-loop type fastening material, and moving the sports activity symbol comprises attaching the sports activity symbol to a first location of the sports activity area to provide a first applied symbol, removing the applied symbol, and re-applying sports activity symbol to a second location of the sports activity area to provide a second applied symbol.

51. The method of any one of claims 42 to 48 wherein the sports activity area comprises a magnetic board and the sports activity symbol is magnetic, and wherein moving the sports activity symbol comprises attaching the magnetic sports activity symbol to a first location of the sports activity area to provide a first applied symbol, removing the applied symbol, and re-applying sports activity symbol to a second location of the sports activity area to provide a second applied symbol.

52. The method of any one of claims 42 to 48 wherein the sports activity area comprises a defined section of a computer screen and the sports activity symbol is a computer-generated icon, and wherein moving the sports activity symbol comprises placing the icon at a first location of the sports activity area to provide a first applied symbol, then moving the icon to a second location of the sports activity area to provide a second applied symbol.

53. A method of goal tracking comprising:
a) writing a goal on an erasable, identified goal statement area of a goal tracking system comprising a substrate comprising a surface, the surface further comprising a sports activity area depicting a field for a sporting event, wherein the goal comprises results other than playing the event;
b) writing at least one step for achieving the goal on the goal statement area, the writing defining a correlation between the step and moving the movable activity symbol between a first, lower value location on a sports activity area located on the surface and a second, higher value location on the sports activity area, the movement indicating progress relative to the goal; and,
c) moving at least one movable sports activity symbol about the sports activity field in accordance with the achievement of the steps.

54. The method of claim 53 wherein the method further comprises writing at least one “short term” word equivalent in a short term writing area and defining at least one short term step, and writing at least one “mid-level” word equivalent in a mid-level writing area and defining at least one mid-level step.

55. The method of claim 53 or 54 wherein the writing is erasable writing.

56. The method of any one of claims 53 to 55 wherein the method further comprises keeping score of progress in at least one scorekeeping area of the surface comprising permanent markings that identify the scorekeeping area.

57. The method of any one of claims 53 to 56 wherein the sports activity area is a football field and the method further comprises moving a football symbol along the field, wherein attaining or losing yards is correlated to successful completion of at least one of the steps.

58. The method of claim 57 wherein the football symbol is initially placed at a first goal line associated with a “dream” word equivalent end zone, then the football symbol is moved after a defined time period, wherein the amount and direction of movement of the football symbol is determined according to the degree of completion of the steps during the defined time period.

59. The method of claim 58 wherein the time period is one week.

60. The method of any one of claims 53 to 59 wherein moving the sports activity symbol comprises applying dry erase ink from a rubber stamp to a first location of the sports activity area to provide a first applied symbol, erasing the applied symbol, and re-applying dry erase ink from the rubber stamp to a second location of sports activity area to provide a second applied symbol.

61. The method of any one of claims 53 to 59 wherein moving the sports activity symbol comprises detaching and reattaching at least one of a male side and a female side of a hook-and-loop type fastening material associated with the sports activity symbol to the corresponding side of the hook-and-loop type fastening material, which is associated with the sports activity area.

62. The method of any one of claims 53 to 59 wherein moving the sports activity symbol comprises detaching and reattaching at least one of a male side and a female side of a hook-and-loop type fastening material associated with the sports activity symbol to the corresponding side of the hook-and-loop type fastening material, which is associated with the sports activity area.

63. The method of any one of claims 53 to 59 wherein the sports activity symbol is magnetized and moving the sports activity symbol comprises detaching and reattaching a the sports activity symbol about a magnetic board.

64. The method of any one of claims 53 to 59 wherein the sports activity area comprises a defined section of a computer screen and the sports activity symbol is a computer-generated icon, and wherein moving the sports activity symbol comprises placing the icon at a first location of the sports activity area to provide a first applied symbol, then moving the icon to a second location of the sports activity area to provide a second applied symbol.
